(19) United States
(12) Patent Application Publication
(10) Pub. No.: US 2025/0374976 A1
(43) Pub. Date: Dec. 11, 2025

(54) Soft Sensing Glove

(71) Applicant: Seoul National University R&DB Foundation, Seoul (KR)

(72) Inventors: Yong Lae Park, Seoul (KR); Myungsun Park, Seoul (KR); Taejun Park, Seoul (KR); Sohee John Yoon, Seoul (KR)

(21) Appl. No.: 19/224,848

(22) Filed: Jun. 1, 2025

(30) Foreign Application Priority Data
Jun. 10, 2024 (KR) 10-2024-0075114
Feb. 6, 2025 (KR) 10-2025-0015203

(51) Int. Cl. A41D 19/00; G01B 7/00; G01B 7/16

(52) U.S. Cl. CPC A41D 19/0027; G01B 7/003; G01B 7/18

(57) ABSTRACT

A soft sensing glove includes a glove in the shape of a hand, wearable by a user; a sensor member that is formed of an elastic material, fixed to an outer side of the glove, and includes one or more sensors whose electrical properties change according to movement of the hand; and a signal processor that receives signals of the sensor to identify the movement of the hand. The signal processor, when a wearer wears the glove, receives the signals of the sensor to detect the size of the hand, and measures the movement of the hand based on the hand size.

### 1. FIELD

The present disclosure relates to a soft sensing glove, and more particularly, to a soft sensing glove capable of measuring hand movements required in fields such as robot hand control and virtual reality (VR), and furthermore, capable of tactile sensing.

### 2. BACKGROUND

Recently, research is being actively conducted on soft sensing gloves for recognizing hand movements, which have high utility among human body movements.

The soft sensing glove can be used to recognize hand movements by receiving signals from sensors attached to the glove and converting them into data. The hand movement data measured from the soft sensing glove can be utilized in fields such as robot hand control and virtual reality (VR).

Conventional hand motion measurement devices have employed methods such as using IMU-based sensors utilizing magnetic fields or estimating hand motions through camera imaging. However, these methods have the problem of being susceptible to interference from the surrounding environment, making it difficult to achieve stable hand motion measurements and resulting in low measurement precision.

In addition, since hand sizes vary among wearers, it has been difficult in the prior art to reflect such differences with a single soft sensing glove, and in order to improve measurement precision, a problem has been that soft sensing gloves needed to be individually manufactured according to the hand size.

### PRIOR ART DOCUMENT

### Patent Document

Korean Laid-Open Patent Publication No. 10-2021-0108201

### SUMMARY

The problem to be solved by the present disclosure is to provide a soft sensing glove which includes a sensor member attached thereto, the sensor member being formed of a stretchable material and having sensors arranged thereon, and when the glove is worn, the size of the wearer's hand is detected and hand movements are recognized based on the detected hand size, thereby enabling high-precision measurement.

Another problem to be solved by the present disclosure is to provide a soft sensing glove in which the region of the sensor member where the sensor is attached is formed of a material or structure having relatively low stiffness, thereby enhancing the sensitivity of the sensors and achieving high measurement precision.

The problems to be solved by the present disclosure are not limited to those mentioned above, and other problems not specifically mentioned will be clearly understood by those of ordinary skill in the art from the following description.

The above-mentioned purposes can be achieved by a soft sensing glove according to the present disclosure, including a glove in the shape of a hand, wearable by a user; a sensor member that is formed of an elastic material, fixed to an outer side of the glove, and includes one or more sensors whose electrical properties change according to movement of a hand; and a signal processor that receives signals of the sensor to identify the movement of the hand, wherein the signal processor, when a wearer wears the glove, receives the signals of the sensor to detect the size of the hand, and measures the movement of the hand based on the hand size.

Herein, the sensor member may be sheet-shaped and may be formed such that a region where the sensor is formed is made of a material having lower stiffness than other regions.

Herein, the sensor member may be sheet-shaped and may be formed such that a region where the sensor is formed is made in a structure having lower stiffness than other regions.

Herein, the sensor member may be formed such that a region where the sensor is formed has a smaller thickness than other regions.

Herein, the sensor member may be formed of silicone.

Herein, the sensor member may be fixed to the glove in a manner that allows attachment and detachment.

Herein, the glove and the sensor member may be fixed in a detachably attachable manner using a hook-and-loop formed at a plurality of points between the glove and the sensor member.

Herein, it is preferable that, when the sensor member is attached to the glove, the sensor member is attached in a stretched state.

Herein, the sensor is formed in a structure in which liquid metal is inserted into a channel formed in the sensor member, and the signal processor may measure deformation by sensing a change in resistance of the liquid metal when a region where the sensor is disposed is deformed due to the movement of the hand.

Herein, the sensor member may include a first sensor member fixed to an outer back-of-hand side of the glove and used to measure the movement of the hand; and a second sensor member fixed to an outer palm side of the glove and used to measure pressure.

As described above, the soft sensing glove according to the present disclosure detects the stretched degree of the sensor member when worn, measures the size of the user's hand, and recognizes hand movements based on the measured hand size, thereby having an advantage of improving measurement accuracy.

In addition, there is an advantage that the sensor member is formed with different stiffness depending on the region, wherein the region where the sensors are formed is made of a material or structure having relatively low stiffness, thereby enhancing the sensitivity and accuracy of the sensors.

Furthermore, there is an advantage that the sensor member is made attachable to and detachable from the glove, and in that the sensor can be accurately positioned even when the hand size of the wearer varies.

In addition, there is an advantage that the sensor member is based on silicone and liquid metal, thereby achieving high measurement accuracy and providing enhanced wearability.

In addition, there is an advantage that it enables not only detection of hand movements but also pressure sensing.

The effects of the present disclosure are not limited to the effects described above, and it should be understood to include all effects that can be inferred from the configuration of the present disclosure described in the detailed description or the claims.

### BRIEF DESCRIPTION OF THE DRAWINGS

FIG. 1 is an exploded perspective view of a soft sensing glove according to an embodiment of the present disclosure.

FIG. 2 illustrates (a) the sensor member of FIG. 1 and (b) a state in which the sensor member is attached to the glove and worn, and illustrate changes in the sensor at that time.

FIG. 3 partially illustrates an attachment surface of the sensor member.

FIG. 4 is a view illustrating regions where the sensors are formed on the sensor member of FIG. 2.

FIG. 5 is a view illustrating the glove according to an embodiment of the present disclosure.

FIG. 6 is an exploded perspective view of the soft sensing glove according to another embodiment of the present disclosure.

### DETAILED DESCRIPTION

Specific details of the embodiments are included in the detailed description and the drawings.

The advantages and features of the present disclosure, and methods for achieving them, will become apparent with reference to the embodiments described in detail below together with the accompanying drawings. However, the present disclosure is not limited to the embodiments disclosed herein and may be implemented in various other forms. The embodiments are merely provided to ensure a complete disclosure of the present disclosure and to fully convey the scope of the disclosure to those of ordinary skill in the art. The present disclosure is defined only by the scope of the claims. Throughout the specification, like reference numerals refer to like elements.

Hereinbelow, the present disclosure will be described with reference to the drawings for explaining a soft sensing glove according embodiments of the present disclosure.

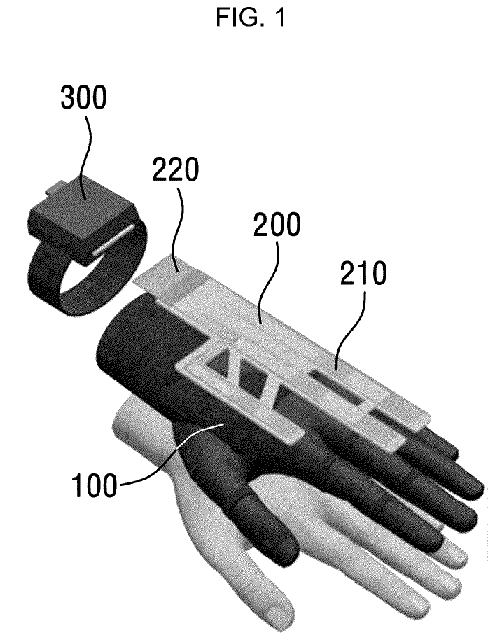

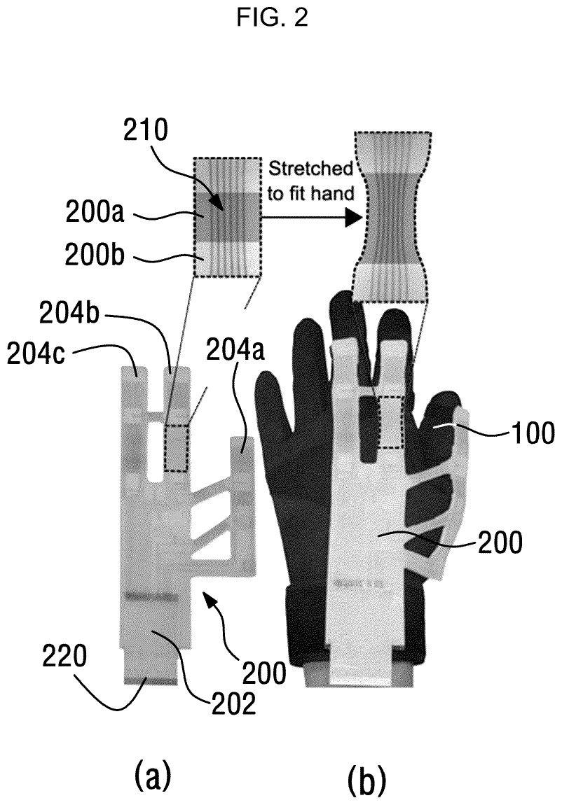

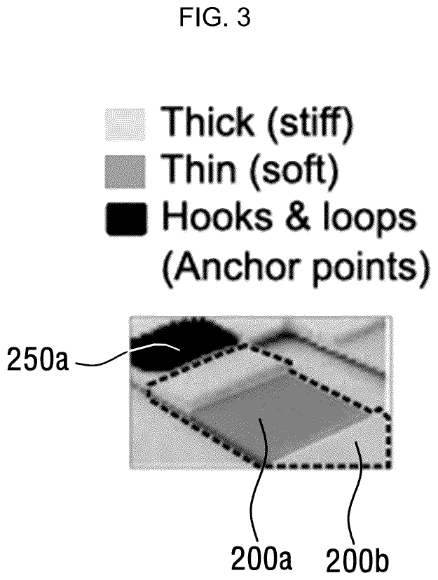

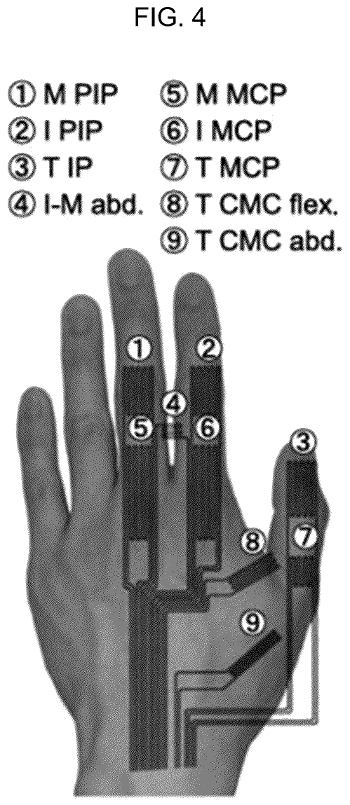

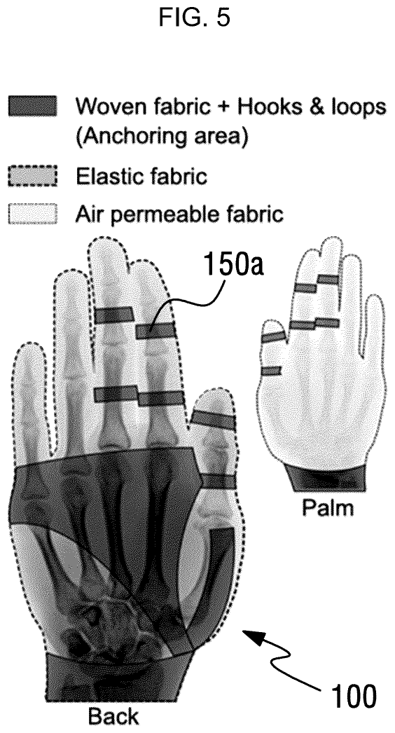

FIG. 1 is an exploded perspective view of a soft sensing glove according to an embodiment of the present disclosure, FIG. 2 illustrates (a) the sensor member of FIG. 1 and (b) a state in which the sensor member is attached to the glove and worn, and illustrate changes in the sensor at that time, FIG. 3 partially illustrates an attachment surface of the sensor member, FIG. 4 is a view illustrating regions where the sensors are formed on the sensor member of FIG. 2, and FIG. 5 is a view illustrating the glove according to an embodiment of the present disclosure.

The soft sensing glove according to an embodiment of the present disclosure may be configured to include a glove 100, a sensor member 200, and a signal processor 300.

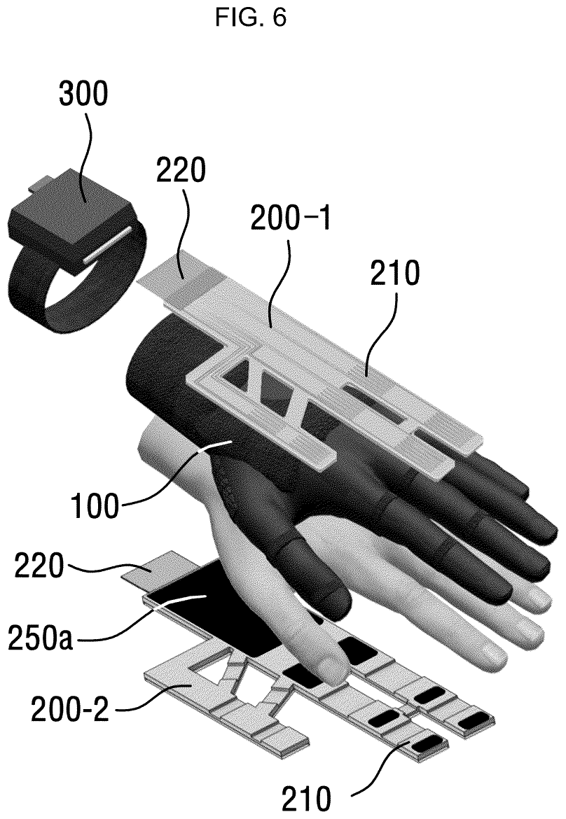

The soft sensing glove according to the present disclosure can be used to measure the rotational angles and positions of each joint forming a hand as well as the size of the hand, for applications such as virtual reality, augmented reality, rehabilitation, and robotic hand control. In particular, it can be used as a means to input data into virtual reality devices by real-time measurement of the rotational angles and positions of finger joints. Additionally, it can be used for collecting and labeling AI training data for human or robotic hand movements, and subsequently for converting such human or robotic hand movements and manual operations into data. Furthermore, as will be described later with reference to FIG. 6, it can also be used to acquire information on hand movements and corresponding tactile information.

The glove 100 is in the form of a conventional glove that covers an entire hand, including fingers, palm, and back of the hand, allowing the user to wear it. However, it may also be in the form of a glove in which only some fingers are worn.

As will be described later with reference to FIG. 5, the glove 100 may be formed of different materials depending on the region. In the present embodiment, the glove 100 is formed of a fabric, although there is no limitation thereto.

The sensor member 200 is made of an elastic material and can be attached to and detached from an outer side of the glove 100. As an example, the sensor member 200 may be formed of silicone. Silicone has good elasticity and low stiffness, making it similar to human skin, thereby providing comfortable wearability when worn on the body and minimizing interference with natural movements.

In this case, a fixing part for allowing attachment and detachment may be formed between the sensor member 200 and the glove 100 so that the sensor member 200 can be attached to and detached from the glove 100. As an example of the fixing part, a hook-and-loop (Velcro) 150a, 250a may be provided at a plurality of points between the outer side of the glove 100 and a rear surface of the sensor member 200 to enable attachment and detachment.

In the present disclosure, it is preferable that the position of a Velcro loop or Velcro tape is fixed respectively on the rear surface of the glove 100 and the sensor member 200 so that the sensor member 200 is stretched when the soft sensing glove is worn. Accordingly, the degree to which the sensor member 200 is stretched may vary depending on the size of the wearer's hand when the soft sensing glove is worn.

At least one or more sensor 210 capable of identifying hand movements (e.g., flexion and extension of the fingers) may be provided on the sensor member 200.

In the present disclosure, the sensor 210 is a sensor whose electrical properties change according to hand movements. In the present embodiment, the sensor 210 may be formed by creating a channel in a region inside the sensor member 200, which is made of silicone, and filling the inside of the channel with liquid metal.

Such a sensor 210 detects changes in the resistance of the liquid metal when the silicone is deformed by hand movements, thereby enabling detection of the hand movements in the region where the sensor 210 is placed. An example of the liquid metal that may be used is Eutectic Gallium-Indium (EGaln), but there is no limitation thereto.

The sensor member 200 may be formed in a sheet shape. As one example, the sheet may be fabricated by 3D printing silicone. Alternatively, the sheet may be fabricated using a blade coating method, in which uncured liquid silicone is applied, leveled with a height-adjustable blade to form a silicone sheet of a predetermined thickness, and then cured. After forming the sheet in this manner, a liquid metal channel may be printed in the sensor 210 region, and the sheet may be cut into a designed shape to complete the fabrication of the sensor member 200.

As shown in FIG. 2, in the present embodiment, the sensor member 200 is formed to include a back-of-hand portion 202 formed to cover a portion of the right side of the back of the hand (based on the left hand) and finger portions 204a, 204b, and 204c formed to be attached to cover up to the distal knuckle of the thumb and the middle knuckles of the index and middle fingers. However, the shape of the sensor member 200 is not limited to the illustrated form and may be variously modified. For example, the sensor member 200 may be formed to cover the entire back of the hand and all five fingers. The shape of the sensor member 200 may vary depending on factors such as the number of sensors and the range of hand movements to be detected.

In the present embodiment, the sensor member 200 is formed to be attachable to the back of the hand portion, but it may also be formed to be attached to the palm portion.

In this case, the sensor 210 may be formed in regions where significant movements occurs, such as at finger joints. In the present embodiment, the sensors 210 are formed on the sensor member 200 so that the sensors 210 are positioned at locations corresponding to nine points of the hand as shown in FIG. 4, but this is not necessarily limited thereto. That is, the number and locations of the sensors 210 are not limited to those illustrated but may vary.

As described above, the sensor member 200 according to the present disclosure is coupled in the hook-and-loop method formed at a plurality of points, thereby allowing fine adjustment of the attachment position so that the sensor 210 can be accurately positioned at a desired location (for example, the center of a finger joint). Accordingly, the sensor 210 can be placed at a desired position even for wearers with different hand sizes.

As shown in the enlarged view of FIG. 2, in a state where the soft sensing glove is worn with the sensor member 200 fixed to the outer side of the glove 100, the sensor member 200 may be stretched, causing deformation in the channels inside the sensor 210. In addition, deformation of the channels inside the sensor 210 may occur according to the movement of the hand in a state where the soft sensing glove is worn. When a channel is deformed, a change in resistance occurs in the liquid metal filling the channel, and this change can be received as a signal to measure variations in hand size or hand movements.

In the present disclosure, the sensor member 200 may be formed such that the region 200a where the sensor 210 is disposed and the remaining region 200b have different stiffness. Preferably, the region 200a where the sensor 210 is disposed has a lower stiffness than the remaining region 200b.

To this end, the sensor member 200 may be formed such that the region 200a where the sensor 210 is formed is made of a material having relatively lower stiffness, and the remaining region 200b is made of a material having relatively higher stiffness.

Alternatively, as shown in FIG. 3, the region 200a where the sensor 210 is formed may be formed with a relatively smaller thickness compared to the remaining region 200b, thereby having a structure with lower stiffness.

As such, in the present disclosure, the region 200a where the sensor 210 is formed may be configured to have relatively low stiffness, so that when the soft sensing glove is initially worn or when the sensor member 200 is deformed due to hand movements, the deformation of the sensor member 200 is concentrated in the region 200a where the sensor 210 is formed, thereby improving the measurement sensitivity and accuracy.

Signal transmission lines for transmitting signals of resistance changes detected from each sensor 210 to a signal processor 300 are formed inside the sensor member 200 and extend toward the wrist area, which is located at a rear side of the back-of-hand portion 202. A connection terminal 220 that is electrically connected to the signal processor 300 may be formed at the rear side of the back-of-hand portion.

The signal processor 300 receives signals from the sensors 210 to measure the size of the hand or hand movements. As shown in FIG. 1, in the present embodiment, the signal processor 300 may be formed in a shape that can be worn on the wearer's wrist, similar to a wristwatch.

The signal processor 300 receives sensor signals from the sensors 210. In the present embodiment, resistance values of the liquid metal are received. In addition, the signal processor 300 may also have a battery formed to supply a sensing current to the sensors 210. Further, the signal processor 300 may receive signals and may include a circuit board equipped with a predetermined computation device, and may directly measure the size of the hand or hand movements based on changes in resistance values from the signals received from the sensor 210. The signal processor 300 may also transmit the measured values related to the size of the hand or movements of the hand to an external device such as a computer, either wirelessly or via a wired connection.

Alternatively, the signal processor 300 may transmit signals received from the sensors 210 to an external computer device, and the external computer device may determine hand movements based on the signals received from the sensors 210. In this case, the signal processor may be interpreted as including both the illustrated signal processor 300 and the external computer device.

As described above, when the sensor member 200 is deformed according to the wearing of the soft sensing glove or movements of the hand after wearing, changes in the resistance value of the liquid metal can be detected to measure the size of the hand or hand movements. In this case, resistance values corresponding to different hand sizes and various finger movements may be measured in advance and stored as data, so that the size of the hand or hand movements can be determined in real time based on changes in the measured resistance values.

As described above, the sensor member 200 is stretched when the wearer puts on the soft sensing glove. At this time, the stretch length of the sensor member 200 may vary depending on the size of the wearer's hand. Accordingly, when an initial wearer wears the glove 100 and adopts a basic hand posture (for example, with all fingers extended), signals from the sensor 210 may be received to detect the size of the hand.

Next, when measuring hand movements based on signals from the sensors 210 while the hand is in motion, the hand movements can be identified with reference to the size of the hand. That is, the resistance value of each sensor 210 may differ depending on the hand size in the initial basic hand posture. By using this initial value as a reference, hand movements can be measured based on subsequent changes in resistance, thereby improving measurement accuracy even for wearers with different hand sizes.

As illustrated in FIG. 5, the glove 100 may be formed of heterogenous materials. For example, the palm side may be formed of a breathable fabric, and the back of the hand, to which the sensor member 200 is attachable and detachable, may be formed of an elastic fabric. Furthermore, a Velcro loop or Velcro tape forming the hook-and-loop 250a may be additionally included in some regions of the back of the hand where the sensor member 200 is attachable and detachable.

FIG. 6 illustrates a soft sensing glove according to another embodiment of the present disclosure. In the following description, the differences from the above-described content with reference to FIGS. 1 to 5 will be mainly explained.

In the present embodiment, the sensor member 200 may be formed of a first sensor member 200-1 and a second sensor member 200-2. That is, compared to the above-described embodiment, the second sensor member 200-2 may be additionally formed. The second sensor member 200-2 may have the same configuration as the sensor member 200 described with reference to FIGS. 1 to 5.

The first sensor member 200-1 may be fixed to an outer back-of-hand side of the glove 100. The second sensor member 200-2 may be fixed to an outer palm side of the glove 100. As described above, the first sensor member 200-1 may be fixed to the outer back-of-hand side of the glove 100 using a hook and loop, and may be used to measure the movement of the hand (more specifically, the movement of the fingers). In the present embodiment, the second sensor member 200-2 is formed with the same configuration as the first sensor member 200-1, and may be fixed to the outer palm side of the glove 100 using a hook and loop, and may be used to measure the pressure applied to the fingers or palm.

The second sensor member 200-2, like the first sensor member 200-1, may be formed of an elastic material and may be attachable and detachable to/from the outer side of the glove 100. That is, the second sensor member 200-2 may be fixed to be attachable and detachable at a plurality of points between the outer palm side of the glove 100 and the rear surface of the second sensor member 200-2 using a hook and loop.

In addition, at least one or more sensor 210 may be formed at a plurality of points in the second sensor member 200-2 as well. In the present embodiment as well, a sensor 210 configured by forming a channel in an region inside the second sensor member 200-2 and filling inside the channel with liquid metal may be arranged, but is not limited thereto and may instead be formed as other known pressure sensors. When the sensor 210 is formed in such a way that liquid metal is filled inside the channel, a change in resistance of the liquid metal may occur due to pressing of the sensor 210 region, thereby enabling pressure sensing. Accordingly, tactile sensing of the palm side may be possible with the second sensor member 200-2.

In the first sensor member 200-1, it is preferable that the sensor 210 is formed in regions where large movements occur, such as finger joints. However, in the second sensor member 200-2, it is preferable that the sensor 210 is formed in regions on the palm side where high pressure is applied, such as the palm and finger knuckles.

Since the second sensor member 200-2 is also coupled using the hook and loop method formed at multiple points, the attachment position can be finely adjusted so that the sensor 210 is accurately positioned at a desired area, and the sensor 210 can be placed at a desired position even for users with different hand sizes. Accordingly, since the stretch length of the second sensor member 200-2, which measures the palm side pressure, varies depending on the hand size of the wearer, it is possible to measure pressure values according to hand size, thereby improving measurement accuracy even for users with different hand sizes.

As described above, in the present embodiment, the movement of the hand can be measured using the measurement values from the first sensor member 200-1, and at the same time, pressure applied to the hand, that is, tactile sensation, can also be measured using the measurement values from the second sensor member 200-2.

While embodiments of the present disclosure have been described above with reference to the accompanying drawings, it will be understood by those skilled in the art that the present disclosure may be implemented in other specific forms without changing the technical spirit or essential features thereof. Therefore, it should be understood that the above-described embodiments are illustrative in all respects and not restrictive.

### REFERENCE NUMERALS

100: GLOVE
150a, 250a: HOOK AND LOOP
200: SENSOR MEMBER
200-1: FIRST SENSOR MEMBER
200-2: SECOND SENSOR MEMBER
200a: REGION WHERE SENSOR IS ARRANGED
200b: REGION WHERE SENSOR IS NOT ARRANGED
202: BACK-OF-HAND PORTION
204a, 204b, 204c: FINGER PORTIONS
210: SENSOR
220: CONNECTION TERMINAL
300: SIGNAL PROCESSOR

What is claimed is:

1. A soft sensing glove comprising:
a glove in the shape of a hand, wearable by a user;
a sensor member that is formed of an elastic material, fixed to an outer side of the glove, and includes one or more sensors whose electrical properties change according to movement of a hand; and
a signal processor that receives signals of the sensor to identify the movement of the hand,
wherein the signal processor, when a wearer wears the glove, receives the signals of the sensor to detect the size of the hand, and measures the movement of the hand based on the hand size.

2. The soft sensing glove according to claim 1,
wherein the sensor member is sheet-shaped and is formed such that a region where the sensor is formed is made of a material having lower stiffness than other regions.

3. The soft sensing glove according to claim 1,
wherein the sensor member is sheet-shaped and is formed such that a region where the sensor is formed is made in a structure having lower stiffness than other regions.

4. The soft sensing glove according to claim 3,
wherein the sensor member is formed such that a region where the sensor is formed has a smaller thickness than other regions.

5. The soft sensing glove according to claim 1,
wherein the sensor member is formed of silicone.

6. The soft sensing glove according to claim 1,
wherein the sensor member is fixed to the glove in a manner that allows attachment and detachment.

7. The soft sensing glove according to claim 6,
wherein the glove and the sensor member are fixed in a detachably attachable manner using a hook-and-loop formed at a plurality of points between the glove and the sensor member.

8. The soft sensing glove according to claim 1,
wherein, when the sensor member is attached to the glove, the sensor member is attached in a stretched state.

9. The soft sensing glove according to claim 1,
wherein the sensor is formed in a structure in which liquid metal is inserted into a channel formed in the sensor member, and the signal processor is configured to measure deformation by sensing a change in resistance of the liquid metal when a region where the sensor is disposed is deformed due to the movement of the hand.

10. The soft sensing glove according to claim 1,
wherein the sensor member comprises:
a first sensor member fixed to an outer back-of-hand side of the glove and used to measure the movement of the hand; and
a second sensor member fixed to an outer palm side of the glove and used to measure pressure.
